(19) United States
(12) Patent Application Publication
(10) Pub. No.: US 2011/0294637 A1
(43) Pub. Date: Dec. 1, 2011

(54) FOLDING DEVICE AND METHOD FOR FOLDING-GLUING MACHINE

(76) Inventors: Andreas Müller, Prilly (CH); Roberto Valterio, Ollon (CH)

(21) Appl. No.: 13/146,686

(22) PCT Filed: Jan. 8, 2010
(86) PCT No.: PCT/EP2010/000051

§ 371 Date: Jul. 28, 2011

(30) Foreign Application Priority Data
Jan. 28, 2009 (EP) 09001145.3

(51) Int. Cl. B31B 1/54; B31B 49/02; B31B 1/62

(52) U.S. Cl. 493/23; 493/151; 493/468; 493/177

(57) ABSTRACT

Folding device for folding paper, cardboard, plastic, corrugated cardboard or similar material blanks running in a folding-gluing machine: a tool (30) installed above the passage plane for the blanks for folding a front flap (21′) of a blank (20′), in which the folding tool (30) is movable alternately between an initial position where the folding tool (30) is able to go through the passage plane for the blanks without interacting with said blanks and a final position where the folding tool (30) is able to press against a lower face (20b′) of the blank (20′) to fold the front flap (21′) into the space located above the passage plane for the blanks.

### CROSS-REFERENCE TO RELATED APPLICATIONS

The present application is a 35 U.S.C. §§371 national phase conversion of PCT/EP2010/000051, filed Jan. 8, 2010, which claims priority of European Application No. 09001145.3, filed Jan. 28, 2009, the contents of which are incorporated by reference herein. The PCT International Application was published in the French language.

### BACKGROUND OF THE INVENTION

1. Technical Field

The present invention relates to a folding method and device for folding paper, cardboard, plastic, corrugated cardboard or similar material blanks in a folding-gluing machine.

The invention also concerns a folding tool for folding paper, cardboard, plastic, corrugated cardboard or similar material blanks.

The invention further concerns a folding-gluing machine, i.e. a machine for transforming blanks into folded boxes.

2. Prior Art

To fabricate a so-called crash-lock bottom carton box, for example, the blank used includes four longitudinal folding lines and one transverse folding line defining longitudinal panels and a transverse flap. For this type of box, the longitudinal panels and the transverse flap are folded in a folding-gluing machine. By transverse flap is meant a flap that folds along a transverse folding line. By front flap is meant a downstream transverse flap. Similarly, the downstream transverse edge of the blank is called the front edge and the upstream transverse edge of the blank is called the rear edge.

With the aim of defining a few terms introduced in the present description and describing the position of certain elements inside the folding-gluing machine, the expressions “operator's side” and “opposite operator's side” refer to a side indicated relative to the longitudinal median axis of the folding-gluing machine. This avoids any confusion with the standard left-hand and right-hand conventions that depend on the point of view of the observer. Likewise, the orientation of certain movements or certain parts is described by the usual terms “longitudinal” and “transverse” with reference to the median axis of the folding-gluing machine, the direction whereof is determined by that of the running of the blanks in the folding-gluing machine. The terms “upstream” and “downstream” for their part refer to the direction of running of the blanks in the folding-gluer.

A folding-gluing machine comprises a series of working stations, for example, a feeder for feeding the box production line blank by blank from a stack, an alignment module, a breaker for prebreaking the first and third longitudinal folding lines of the blank by an angle between 90° and 180°, a folding module for folding the front flaps of the blank by an angle of 180°, a gluing station, a folder for folding the second and fourth longitudinal folding lines of the blank, a pressing device that compresses the second and fourth longitudinal folding lines, and a transfer module that lays down the boxes in shingle stream on a receiving module that receives the boxes while maintaining them pressed to enable the glue to dry. Blanks are conveyed from one station to another by conveyor belts which, by friction, take up the blanks between a lower conveyor and an upper conveyor. The lower conveyor is conventionally provided with lower belts and the upper conveyor is provided either with upper belts or with upper pressure rollers. The points of contact of the lower conveyor with the upper conveyor define the conveying path for the blanks.

As an alternative, the blanks can be held against the belts of the lower conveyor without the assistance of an upper conveyor. Examples of devices for conveying blanks without upper conveyor are described in the U.S. Pat. No. 4,108,302 and WO-97,14634. In these known devices, the lower conveyor is a conveyor with standard belts cooperating with a vacuum chamber. Another example of a device for conveying blanks without upper conveyor is described in the U.S. Pat. No. 4,614,512. In this known device, the lower conveyor is a conveyor with belt provided with suction members.

The lower conveyor generally includes a plurality of longitudinal beams each supporting an endless conveyor belt guided by pulleys and rollers. Each beam is mounted on bearings to slide laterally along one or more displacement slides attached transversely between two longitudinal frames. To adapt the lateral position of the beams to the format of the blanks to be processed, each beam is displaced laterally by one or more parallel screws rotatably mounted between the frames, the threaded portions of the screws being engaged respectively in transverse threaded holes of the beams.

A front flap is generally folded thanks to a device including one or more elastic hooks suspended from a crossmember located above the passage plane for the blanks, the lower end of these hooks penetrating in the passage plane for the blanks (see for example as in the U.S. Pat. No. 3,285,144).

Also known are devices placed under the passage plane for the blanks in which folding of the front flap is initiated by pivoting lifting fingers (see for example the U.S. Pat. No. 4,052,932).

In folding devices using an elastic hook to fold the front flap, the elastic hook swings about a transverse axis between an initial position in which the lower end of the hook is below the passage plane for the blanks and a final position in which the lower end of the hook is above the passage plane for the blanks. The swinging angle of the elastic hook varies as a function of the length of the front flap and the length of the hook. For a front flap 30 mm long and a hook 80 mm long, the hook typically swings through an angle of approximately 30°. The hook is elastic in that it is provided with a biaising spring. The swinging movement is triggered by the blanks passage pushing the lower end of the hook.

The initial position corresponds indeed to the rest position of the elastic hook, in which position the hook goes through the blanks passage. Thus, when a blank conveyed by the conveyor arrives perpendicularly to the folding device, the front edge of the blank pushes on the lower end of the hook, the hook swings toward the final position lifting the front flap into the space located above the passage plane for the blanks. On swinging in this manner, the biasing spring accumulates energy. This accumulation reaches a maximum when the hook reaches the final position. After the hook has reached the final position, the hook releases the front flap, which also releases the energy accumulated by the spring. Releasing the energy of the spring causes the elastic spring to return to the initial position.

The elastic hook is returned to the initial position in two stages. In a first stage, the hook passes by the passage plane for the blanks, where it is stopped by the longitudinal panel of the blank located upstream of the front flap that has been folded. Then, in a second stage, with the blank continuing to move forward, the hook slides over the longitudinal panel as far as the rear edge of the blank, where it is released and completes its return stroke to the initial position. The folding cycle with an elastic hook therefore is a three periods cycle: a period of swinging from the initial position to the final position and two periods of swinging from the final position to the initial position. Each time a blank passes this cycle is triggered by the action of the front edge of the blank on the hook, which is not satisfactory.

Indeed, when a blank pushes the lower end of the elastic hook, the hook is liable to mark the front edge of the blank and thus spoil the blank. The severity of this problem increases in proportion to the speed at which the blanks are conveyed. Similarly, when the hook swings from the final position to the initial position, it strikes the longitudinal panel of the blank before rubbing on it, which can also mark the blank.

Moreover, when the blanks are conveyed at very high speed, the hook sometimes bounces on the front edge of a blank, which causes a folding quality problem since some front flaps then fail to be folded.

Another problem concerns noise. When the hook strikes the longitudinal panel of a blank, an impact noise is heard. The level of this noise varies with the speed at which the blanks are conveyed and the material of the blanks. For example, the impact noise on a corrugated cardboard blank is louder than the impact noise on a solid board. These impact noises degrades the working environment.

In folding devices using a pivoting lifting finger placed under the passage plane for the blanks, the lifting finger swings about a transverse axis between an initial position in which the finger is under the passage plane for the blanks and a final position in which the finger goes through the passage plane for the blanks for going above the passage plane for the blanks. The swinging motion of the finger is triggered by a jack synchronized with the passage of the blanks.

Indeed, when a blank conveyed by the conveyor arrives perpendicularly to the folding device, a detector, for example a photo-electric cell, generates a signal and sends it to the jack, which causes the finger to swing from the initial position to the final position. On swinging in this way, the finger pushes on the front flap, which starts to be folded into the space located above the passage plane for the blanks. This start of folding allows the folding angle to pass from 180° to approximately 150°. The folding angle is the angle between the front flap and the adjacent longitudinal panel upstream of the front flap.

To complete the folding of the front flap, the folding finger swings toward the initial position, and by swinging in this way the front flap passes between the lifting finger and a fixed folding crossmember located above the passage plane for the blanks. This arrangement effects complete folding of the front flap.

Although such a folding device limits marks on the blanks as well as the noise problem caused by impact noise, the fact that it is below the passage plane for the blanks while the front flap is folded into the space located above the passage plane for the blanks, i.e. on the side opposite the folding device, restricts the action of the folding tool, which necessitates the use of a folding crossmember to complete the folding of the front flap, which is not satisfactory.

Moreover, because they are located below the passage plane for the blanks, adjusting the various elements constituting this folding device (lifting finger, jack, jack control system, etc.) makes it obligatory to operate in an area of the folding-gluing machine to which access is difficult, which is not satisfactory.

### STATEMENT OF THE INVENTION

A first object of the invention is to remedy the aforementioned drawbacks by proposing a device for folding paper, cardboard, plastic, corrugated cardboard or similar material blanks that avoids both marking of the blanks with a folding tool and the noise of impact of the folding tool on the blanks, as well as avoiding placement of the folding device on the opposite side to the space into which the front flap is folded. To this end, the invention comprises an inventive folding device.

A second object of the present invention is to propose a tool for folding blanks that is particularly suitable for the folding device of the invention. To this end, the invention comprises an inventive folding tool.

A third object of the present invention is to propose a folding method implemented by a folding device of the invention. To this end, the invention comprises an inventive folding method.

A fourth object of the present invention is to propose a folding-gluing machine fitted with a folding device of the invention. To this end, the invention consists comprises an inventive folding-gluing machine.

Thanks to the folding device hereof, the folding tool does not strike the blanks, either on the front edge or on the longitudinal panel upstream of the front flap to be folded, which prevents marking of the blanks during folding of the front flaps. Similarly, the noise problems caused by impact noise are eliminated. Moreover, being placed above the passage plane for the blanks, i.e. in the space into which the front flaps are folded, the device of the invention avoids the use of a folding crossmember to effect complete folding of the front flaps.

Thanks to the folding tool hereof, contact between the blanks and the folding tool is a point or rectilinear contact throughout the folding of the front flaps, which ensures perfect guiding of the blanks during the folding.

Further, thanks to the folding method hereof, contact between the folding tool and the blank is without shock or impact, which avoids marking the blanks when folding the front flaps and generating noise problems.

Finally, thanks to the folding-gluing machine hereof, the folded boxes production is of better quality and the working environment is quieter.

Other objects and advantages of the invention will become more clearly apparent in the course of the description of one embodiment given with reference to the appended drawings.

### BRIEF DESCRIPTION OF THE FIGURES OF THE DRAWINGS

FIG. 1 is a perspective view of a prior art conveyor.

FIGS. 2a-2c are perspective views of a portion of a prior art folding device.

FIGS. 3a-3f are views in cross section of a portion of a folding device of the invention.

### BEST WAY TO IMPLEMENT THE INVENTION

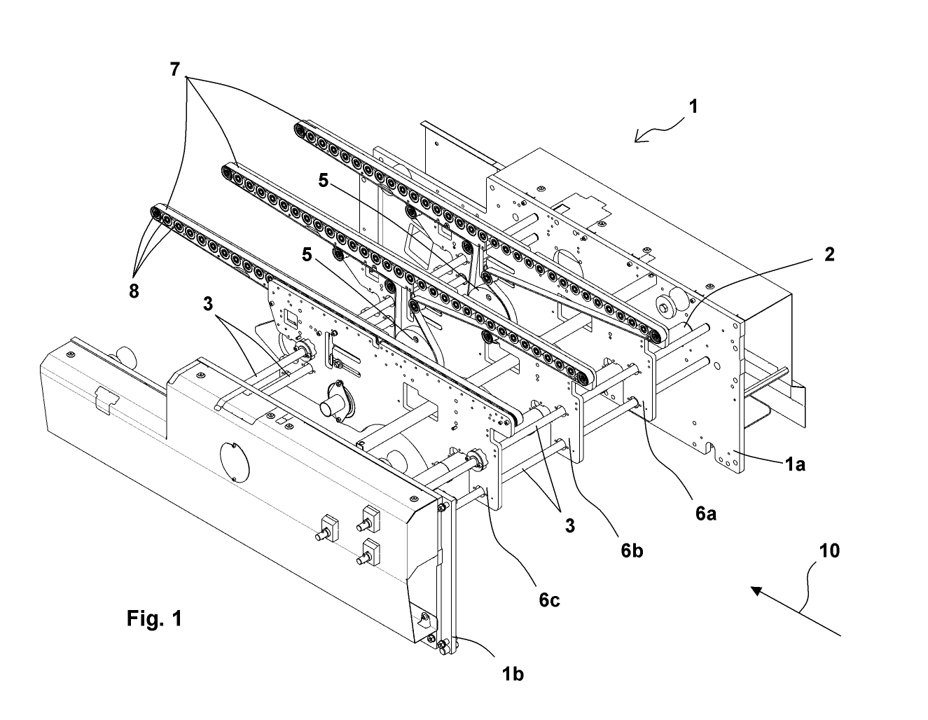

FIG. 1 shows a prior art conveyor 1. The arrow 10 indicates the direction of running for the blanks, also referred to as the conveying path. Such a conveyor generally comprises two spaced parallel longitudinal frames 1a, 1b. Each frame has two major faces: an inner face and an outer face, the inner face of one frame facing the inner face of the other frame. In the present example, the frame 1a is located on the side opposite the operator and the frame 1b is located on the operator side. Parallel cylindrical displacement slides 2 (only one slide is represented), pairs of parallel screws 3 and a drive shaft (not shown) rotatably mounted between the two frames are transversely disposed between the two frames 1a, 1b. The displacement slides 2 are built into the frames 1a, 1b at each of their ends and are intended to support three parallel longitudinal beams 6a, 6b, 6c mounted side-by-side and each supporting an endless conveyor belt 7 resting on a horizontal hard plane defined by a series of rollers 8. Each longitudinal beam can move transversely between the frames 1a, 1b, along the displacement slides 2, as a function of the format of the blanks to be processed.

Devices (not shown) for pressing the blanks against the conveyor belts 7 are disposed above certain portions of the beams 6a, 6b, 6c. These pressing devices can be constituted by a series of rollers maintained in a lowered position by springs or an endless belt the lower run of which is urged downward.

To modify the transverse position of the beams 6a, 6b, 6c, they are mounted in a helical connection with the displacement screws 3. Transverse movement of each beam is controlled indeed by a pair of parallel screws 3 the threaded portions of which are respectively engaged in transverse threaded orifices of the beam, which screws are fixed in translation but free to rotate between the frames 1a, 1b. One or more electric motors (not shown) are provided for turning the screws 3.

Each endless conveyor belt 7 is supported by rollers and a drive pulley 5. The drive pulleys 5 are coaxial and mounted to rotate freely on their respective beam. To drive the conveyor belts 7, the drive shaft has a hexagonal section cooperating with a transverse orifice of matching shape provided on the axis of each drive pulley 5. Thus, when a beam 6a, 6b or 6c is moved laterally by a pair of adjusting screws 3, it slides along the displacement slides 2 and along the drive shaft.

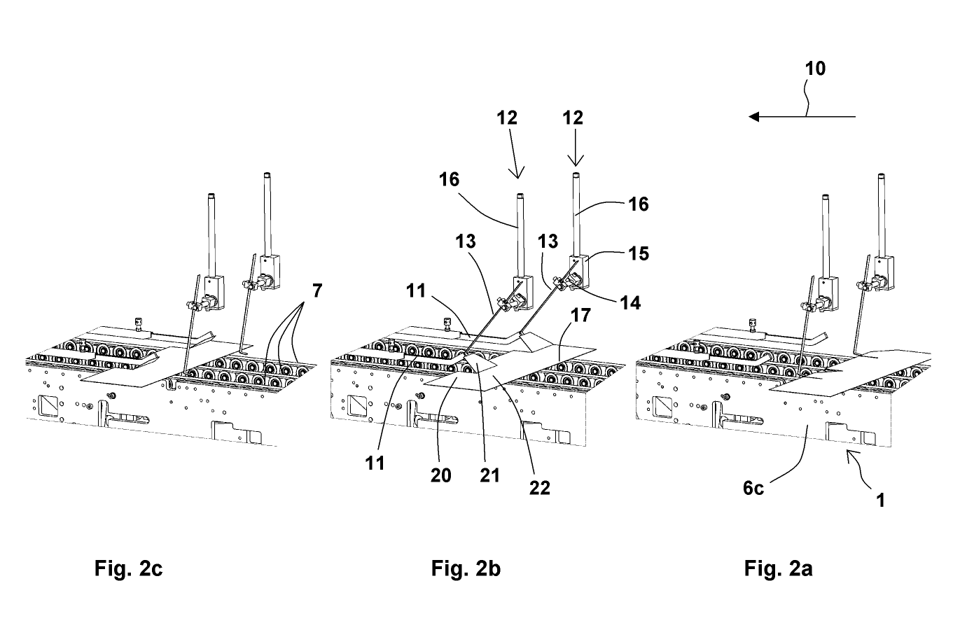

FIGS. 2a to 2c show a known folding device and a conveyor 1 similar to that described with reference to FIG. 1. This device comprises two mobile folding members 12 suspended from a crossmember (not shown) placed above the passage plane for the blanks and two upper guides 11. Each folding member 12 comprises an elastic folding hook 13 constituted by an L-shaped metal blade. The lower end of the folding hook 13 goes through the passage plane for the blanks while the upper end of the folding hook is secured to a shaft 14 pivoting in a casing 15 about a transverse axis. A rigid rod 16 fixes the casing 15 to the crossmember. A biasing spring accommodated in the casing 15 exerts on the shaft 14 a torque that tends to maintain the lower end of the hook 13 through the passage plane for the blanks. To illustrate the mode of operation a blank 20 with two front flaps 21 to be folded is represented in different phases of a folding cycle. FIG. 2a shows this device in a first phase corresponding to the start of a folding cycle. In this phase, the blank 20 arrives in the folding device according to the direction of running 10. The front flaps 21 and the longitudinal panels 22 of the blank are in substantially the same horizontal plane. The folding hooks 13 are in the initial position, i.e. their lower end goes through the passage plane for the blank 20.

FIG. 2b shows the same device as the one of FIG. 2a but in a later phase corresponding to a certain period of time later in the folding cycle. In this phase, the blank passes perpendicularly to the folding members 12, as it passes, the front flaps 21 are caught by the lower end of the folding hooks 13. As it continues to advance, the front edge of the blank urges on the hooks 13. Under the effect of this urging, the hooks 13 swing on their transverse axis above the passage plane for the blank 20. The swinging of the hooks causes at the same time the springs accommodated in the casings 15 to load. The front flaps 21 begin to be folded, rising above the horizontal plane, i.e. into the space located above the passage plane for the blanks while the remainder of the blank 20 is held against the conveyor belts 7 by any means known in the art, for example pressing devices such as those described above (not shown).

In a later phase shown in FIG. 2c, the blank 20 passes under the upper guides 11. These guides are rigid slides extending in the longitudinal direction, the function of these guides being to complete the folding of the front flaps 21. Indeed, when the hooks 13 release the flaps 21, the latter come to press against a marginal portion of the upper guides 11. Because the blank 20 continues to advance, the flaps 21 completes their folding by sliding under the guides 11.

After releasing the flaps 21, the holding hooks 13 are brought back through the passage plane for the blanks by action of their respective biasing springs. Returning to the initial position is done in two stages. In a first stage, the folding hooks 13 pass via the passage plane for the blanks where it is stopped by the longitudinal panel 22 upstream of the front flap 21. Then, in a second stage, the blank continuing to advance, the hooks 13 slide on the longitudinal panel 22 as far as the rear edge 17 of the blank, where it is released and completes its return stroke to the initial position. A new folding cycle can then begin as soon as a new blank arrives.

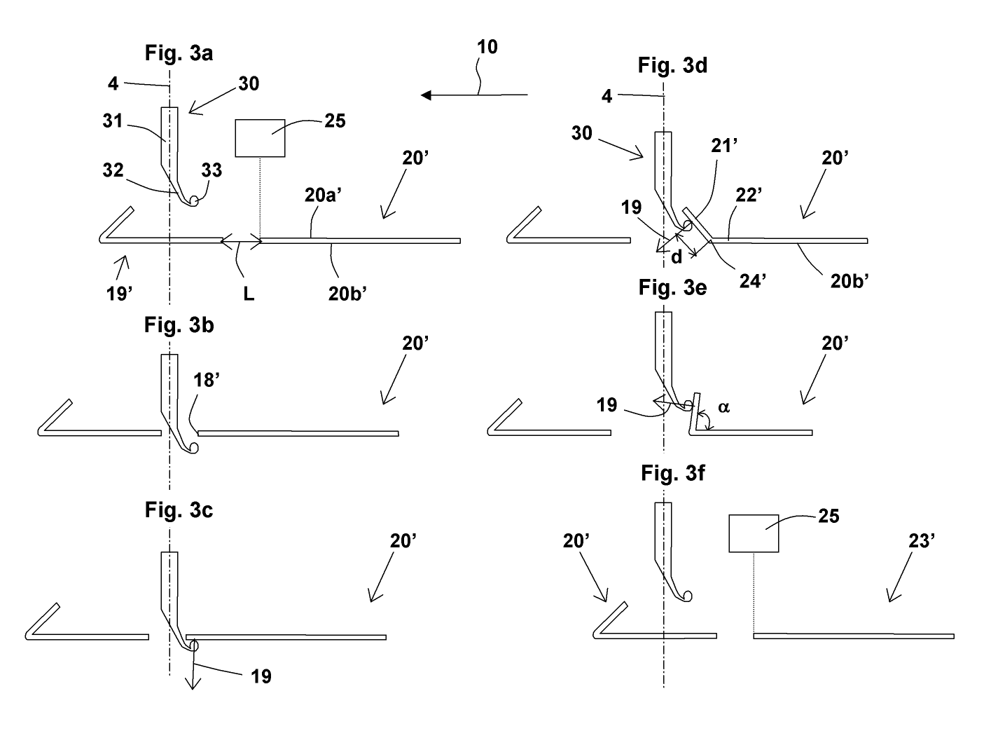

FIGS. 3a-3f show diagrammatically a folding device according to the invention in various phases of a folding cycle. This device cooperates with a conveyor (not shown) similar to that described with reference to FIG. 1.

The folding device according to the invention comprises a mobile folding tool 30 fixed to a crossmember (not shown) placed above the passage plane for the blanks. The folding tool 30 is mobile in that it is able to be imparted with an alternating working movement, in the present example a vertical reciprocating movement along a vertical axis 4. The reciprocating movement of the tool 30 is driven by an electric actuator, for example a linear motor (not shown) comprising a vertical slide that is not free to rotate about the axis 4, controlled by opto-electronic reader means. In the standard way, a photo-electric cell 25 (shown only in FIGS. 3a and 3f) is used to detect the passage of a blank 20′. This cell is connected to an input of a control unit (not shown) an output of which is connected to the linear motor for driving the vertical slide. This control unit generates a supply current for the linear motor and to operate on at least three parameters of the motor: the direction of movement of the vertical slide (going up or down), the speed of displacement of the vertical slide, and the amplitude of that displacement. The target value of these three parameters is calculated by a calculation unit (not shown) as a function of the free space L, the length of the blanks, the length of the front flaps, the conveying speed for the blanks and the dimensions of the folding tool 30.

The folding tool 30 is constituted with an elongate body 31 oriented vertically. The upper end of the elongate body 31 is coupled to the vertical slide of the linear motor while the lower end of the elongate body 31 is extended by a hook 32 ended with a rounded shape.

The rounded shape advantageously forms a protrusion 33 at the end of the hook 32. The protrusion 33 preferably has a spherical shape or a cylindrical shape with a transverse axis, so that as seen in a longitudinal axial section plane the protrusion 33 has an essentially circular section (see FIGS. 3a-3f). The opening of the hook 32 faces in the opposite direction to that of the arrow 10 that indicates the direction of running for the blanks.

To illustrate the operating mode specific to the invention, a blank 20′ with a front flap 21′ is represented in various phases for folding the front flap. FIG. 3a shows the folding device according to the invention in a first phase corresponding to the start of a folding cycle. In this phase, a blank 19′ leaves the folding device after being folded while the blank 20′ arrives in the folding device in order to be folded. The rear edge of the blank 19′ is separated from the front edge of the blank 20′ by a free space ‘L’. The front edge 18′ of the blank 20′ is detected by the photoelectric cell 25 located upstream of the folding tool 30, a signal is sent to the control unit. The front flap 21′ and the longitudinal panel 22′ of the blank are in substantially the same horizontal plane. The folding tool 30 is in the initial position; in this position, the folding tool 30 is outside the passage plane for the blanks. To be more precise, the lower end of the folding tool 30, realized with the protrusion 33, is located above the passage plane for the blanks.

FIG. 3b shows the same device as the one of FIG. 3a but in a later phase corresponding to a certain period of time later in the folding cycle. In this phase, the free space ‘L’ comes perpendicularly to the folding tool 30; in this position the control unit actuates the linear motor to lower the lower end of the folding tool 30 below the passage plane for the blanks. During the lowering, the folding tool 30 goes through the free space ‘L’ without interacting with the blanks, i.e. without touching the blank 19′ or 20′. At the end of the lowering, the folding tool 30 is across the passage plane for the blanks; this position corresponds to the final position of the folding tool.

In a later phase shown in FIG. 3c, the control unit actuates the linear motor to raise the lower end of the folding tool 30 to the level of the passage plane for the blanks so that the lower end of the folding tool 30 bears on the blank 20′. To be more precise, the protrusion 33 bears on the lower face 20b′ of the blank 20′ close to the front edge 18′, at a distance ‘d’ from the transverse folding line 24′ of the front flap 21′ (see FIG. 3d). The lower face 20b′ is the face of the blank 20′ facing the space located below the passage plane for the blanks. In the case in which the protrusion 33 is of spherical shape, contact between the blank 20′ and the folding tool 30 is a point contact symbolized by the arrow 19. The arrow 19 represents the vector normal to the plane tangential to the point of contact between the folding tool 30 and the blank 20′, oriented from the blank toward the folding tool.

In the different case in which the protuberance 33 has a cylindrical shape with a transverse axis, contact between the blank 20′ and the folding tool 30 is a rectilinear contact. In this case, the arrow 19 represents the vector normal to the plane tangential to the points of contact between the folding tool 30 and the blank 20′.

Thanks to the spherical or cylindrical shape of the protrusion 33, contact between the blank 20′ and the folding tool 30 is a point or rectilinear contact all the time of the folding of said front flap 21′, which ensures a perfect guiding of the blank 20′ throughout the folding of said front flap 21′.

In a later phase shown in FIG. 3d, the linear motor raises the lower end of the folding tool 30 above the passage plane for the blanks. During this raising, the protrusion 33 urges on the lower face 20b′ of the blank 20′, starting folding of the front flap 21′ into the space located above the passage plane for the blanks.

In a later phase shown in FIG. 3e, the blank 20′ continues to advance. Because the folding tool 30 is still contacting the lower face 20b′ of the blank 20′, the front flap 21′ pivots about the protrusion 33. By this arrangement, a full folding of the front flap 21′ is effected.

Thanks to the invention, it is possible to effect a folding of the front flaps without interacting with the front edge of the blanks, which avoids damaging the blanks.

At the end of folding in accordance with the invention, the folding angle α is less than 150°. The folding angle α is preferably less than 90°. The folding angle α is the angle between the front flap 21′ and the adjacent longitudinal panel 22′.

In a later phase shown in FIG. 3f, the folding tool 30 returns to the initial position; the blank 20′ leaves the folding device after being folded while a new blank 23′ arrives at the folding device in order to be folded. A new folding cycle is triggered when each blank passes, to be more precise each time that the front edge of a blank is detected by the photoelectric cell 25. Thus the vertical reciprocating movement of the folding tool 30 is effected synchronously with the passage of the blanks.

The distance ‘d’ is advantageously calculated by the calculation unit, which transmits it to the control unit to check the distance ‘d’ throughout the folding of the front flaps. The distance ‘d’ is preferably chosen as large as possible at the start of folding to have a maximum lever effect on the front flap 21′ and thereby to facilitate folding it about the transverse folding line 24′. The distance ‘d’ at the start of folding is typically equal to approximately 75% of the length of the front flap 21′.

On the other hand, at the end of folding, the distance ‘d’ can be different, depending on the stiffness of the blank. For a blank of low stiffness, for example a paper or cardboard blank, it is preferable indeed to reduce the distance ‘d’ during folding so as to prevent the front flap 21′ curving without folding, while for a blank of high stiffness, for example a plastic or corrugated cardboard blank, it is preferable to maintain the distance ‘d’ constant during folding to maintain a maximum lever effect on the front flap 21′.

The above shown example shows a folding device comprising a single folding tool, but it goes without saying that the number of folding tools depends on the number of front flaps to be folded; thus, for a blank with two front flaps to be folded, the device includes two folding tools.

Instead of coupling the folding tool to the vertical slide of the linear motor, it is possible to design a folding tool that is directly integrated into the linear motor, for example by arranging the lower end of the vertical slide as a hook.

As an alternative, the reciprocating movement of the folding tool can be effected by a crank-connecting rod system (not shown).

Similarly, the movement of the folding tool is not necessarily a vertical reciprocating movement. For example, it can be an oblique reciprocating movement or a movement of pivoting about an axis.

Finally, although the above example shows a passage plane for the blanks whose surface is planar, the invention is not limited to this example; the surface of the passage plane for the blanks can be curved.

1. A folding device which is adjustable above a passage plane for blanks in a folding-gluing machine, the device comprising a folding tool configured for folding a front flap of a blank, the folding tool being movable alternately between an initial position where the folding tool is outside the passage plane for the blanks and is configured and operable to cross the plane without interacting with the blanks and a final position where the folding tool extends across the passage plane for the blanks and is able to fold the front flap into the space located above the passage plane for the blanks by pressing against a lower face of the blank.

2. A folding device according to claim 1, wherein the folding tool is movable in translation between the initial position and the final position.

3. A folding device according to claim 1, wherein a working movement of the folding tool is a substantially vertical reciprocating movement between the initial position and the final position.

4. A folding device according to claim 3, further comprising an electrical actuator to which the folding tool is coupled for causing the reciprocating movement of the folding tool.

5. A folding device according to claim 4, wherein the electrical actuator is synchronized with the passage of the blanks past the folding tool.

6. A folding tool for folding front flaps of blanks in a folding-gluing machine, comprising an elongate body having one end extended by a hook which ends with a rounded shape.

7. A folding tool according to claim 6, wherein the rounded shape forms a protrusion at the end of the hook.

8. A folding tool according to claim 7, wherein the protrusion has an essentially circular section in an axial longitudinal section plane.

9. A folding tool according to claim 6 further comprising the protrusion is configured to press on a lower face of a front flap of a blank and the protrusion is shaped so that contact between the blank and the folding tool is a point or a rectilinear contact throughout the folding of said front flap.

10. A method for folding blanks running in a folding-gluing machine, comprising the following steps:
(a) placing a tool for folding a front flap of a blank above a passage plane for the blanks;
(b) lowering the folding tool below the passage plane for the blanks between two successive blanks without touching either of the blanks;
(c) pressing the folding tool against a lower face of the blank;
(d) raising the folding tool above the passage plane for the blanks for folding the front flap into the space located above the passage plane for the blanks;
(e) repeating steps (b) to (d) on each passage of a blank.

11. A method according to claim 10, wherein lowering and raising of the folding tool is effected by an electrical actuator to which the folding tool is coupled.

12. A method according to claim 10, wherein the lowering and raising of the folding tool are synchronized with the passage of the blanks.

13. A method according to claim 10 wherein a folding angle α between the front flap and the longitudinal panel upstream of the front flap is less than 150°.

14. A method according to claim 13, wherein the folding angle α is less than 90°.

15. A machine for folding-gluing blanks, comprising a conveyor configured to convey the blanks along a conveying path, the conveyor comprising at least one longitudinal beam supporting at least one endless conveyor belt, and a guide for the conveyor belt along the conveying path and a folding device according to claim 1.

16. A machine for folding blanks comprising a folding device according to claim 1 and a conveyor for moving the blanks along the passage plane and past the folding tool.

17. A machine for folding blanks according to claim 16, wherein the folding tool is movable in translation between the initial position and the final position.

18. A machine for folding blanks according to claim 16, further comprising
an electrical actuator to which the folding tool is coupled for causing the reciprocating movement of the folding tool wherein the electrical actuator is synchronized with the passage of the blanks past the folding tool.

19. A machine for folding blanks according to claim 16, wherein the folding tool is configured for folding front flaps of blanks in a folding-gluing machine, and the folding tool comprises an elongate body having one end extended by a hook which ends with a rounded shape for pressing against the lower face of the blanks.

20. A machine for folding blanks according to claim 18, wherein the blanks are spaced apart along the conveyor and the actuator is configured and operative for moving the folding tool to cross the passage plane between successive blanks on the conveyor.
